(19) United States
(12) Patent Application Publication
(10) Pub. No.: US 2018/0329462 A1
(43) Pub. Date: Nov. 15, 2018

(54) 360 DEGREE MICRO HINGE FOR SUPER THIN SYSTEM

(71) Applicant: INTEL CORPORATION, Santa Clara, CA (US)

(72) Inventors: Denica N. Larsen, Hillsboro, OR (US); Chunlin Bai, Shenzhen (CN); Prosenjit Ghosh, Portland, OR (US)

(73) Assignee: INTEL CORPORATION, Santa Clara, CA (US)

(21) Appl. No.: 15/776,916

(22) PCT Filed: Dec. 26, 2015
(86) PCT No.: PCT/US2015/000374

§ 371 Date: May 17, 2018

(51) Int. Cl. G06F 1/16

(52) U.S. Cl. CPC G06F 1/1681

(57) ABSTRACT

An apparatus including a hinge assembly is described herein. The hinge assembly including a plurality of substantially parallel hinges, each said hinge of the plurality being attached to at least one adjacent said hinge, wherein a first outermost hinge is coupled to a first housing and a second outermost hinge is coupled to a second housing, each said hinge of the plurality to provide a respective range of rotation to the hinge assembly such that the first and second housings may be rotated relative to each other about the hinge assembly within a range of approximately between 0 degrees and 360 degrees.

### TECHNICAL FIELD

This disclosure relates generally to hinges. Specifically, this disclosure relates to hinges for mating components in a rotatable fashion.

### BACKGROUND ART

It is desirable for laptop computers and notebook computers to be as thin as possible. The hinge of the device is a limiting factor in how thin the computer can be. Some known hinges that could accommodate an extremely thin computer have a large number of pieces and are prohibitively expensive. Other known hinges do not place the two hinged pieces in a same plane when the computer is laid flat. That is, there is a step or change in the vertical level between the screen and the keyboard, for example. Yet other known hinges have a thickness that is greater than the combined thickness of the two hinged pieces, e.g., the screen and the keyboard.

### BRIEF DESCRIPTION OF THE DRAWINGS

FIG. 1A is a fragmentary, perspective view of one embodiment of a hinge assembly of the present disclosure;

FIG. 1B is an enlarged view of a hinge assembly in an open structure;

FIG. 1C is an enlarged view of a hinge assembly in a closed structure;

FIG. 2 is a fragmentary, exploded view of the slider and two axles of the assembly of FIG. 1;

FIG. 3 is a cross-sectional view of the hinge assembly of FIG. 1A along line 3-3;

FIG. 4 is a fragmentary, plan view of the slider and two axles of the assembly of FIG. 1A;

FIG. 5 is a fragmentary, perspective view of another embodiment of a geared hinge assembly of the present disclosure;

FIG. 6 is a fragmentary, partially exploded view of the geared hinge assembly of FIG. 5;

FIG. 7 is a fragmentary, perspective view of a laptop computer including yet another embodiment of a hinge assembly of the present disclosure in a closed position;

FIG. 8 is a fragmentary, perspective view of the laptop computer of FIG. 7 in an open position;

FIG. 9 is a perspective view of the hinge assembly of the laptop computer of FIG. 7;

FIG. 10 is a perspective, partially exploded view of the hinge assembly of FIG. 9;

FIG. 11 is a fragmentary, perspective view of a laptop computer including still another embodiment of a hinge assembly of the present disclosure in a closed position;

FIG. 12 is a fragmentary, plan view of the laptop computer of FIG. 11 in an open position;

FIG. 13 is a fragmentary, perspective view of the laptop computer of FIG. 11 in an open position;

FIG. 14 is a perspective view of one of the hinge assemblies of the laptop computer of FIG. 11;

FIG. 15 is a perspective view of the other one of the hinge assemblies of the laptop computer of FIG. 11;

FIG. 16 is a schematic view of a further embodiment of a hinge assembly of the present disclosure;

FIG. 17 is a schematic view of two of the rollers of the hinge assembly of FIG. 16;

FIG. 18 is a fragmentary, perspective view of a laptop computer including still another embodiment of a hinge assembly of the present invention in a closed position;

FIG. 19 is a fragmentary, perspective view of the laptop computer of FIG. 18 in an open position;

FIG. 20 is a schematic view of a laptop computer including another embodiment of a hinge assembly of the present disclosure;

FIG. 21 is a top view of the hinge assembly of FIG. 20 along line 21-21; and

FIG. 22 is a cross-sectional view of the hinge assembly of FIG. 21 along line 22-22.

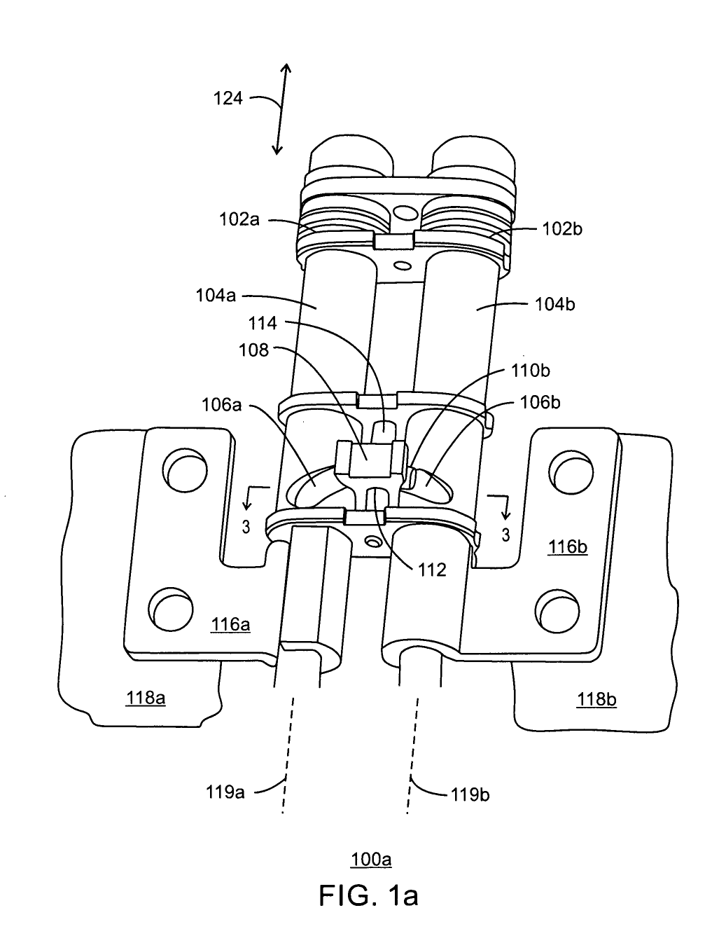

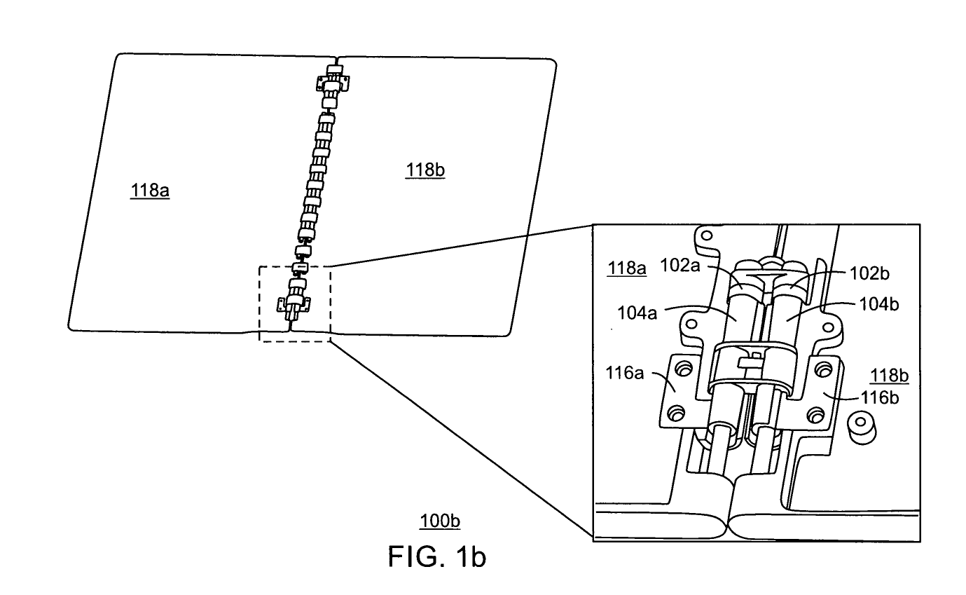

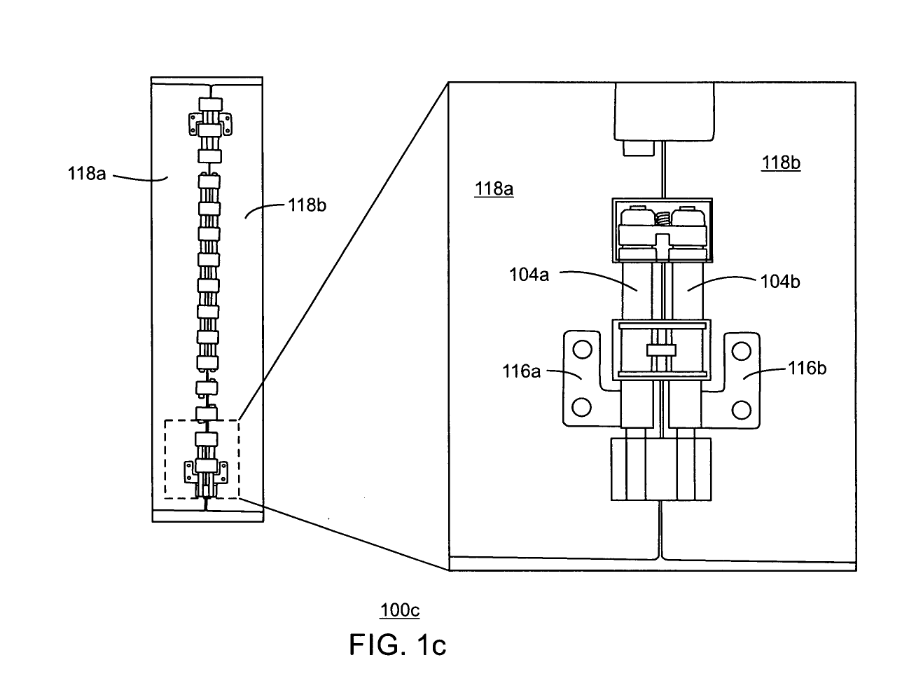

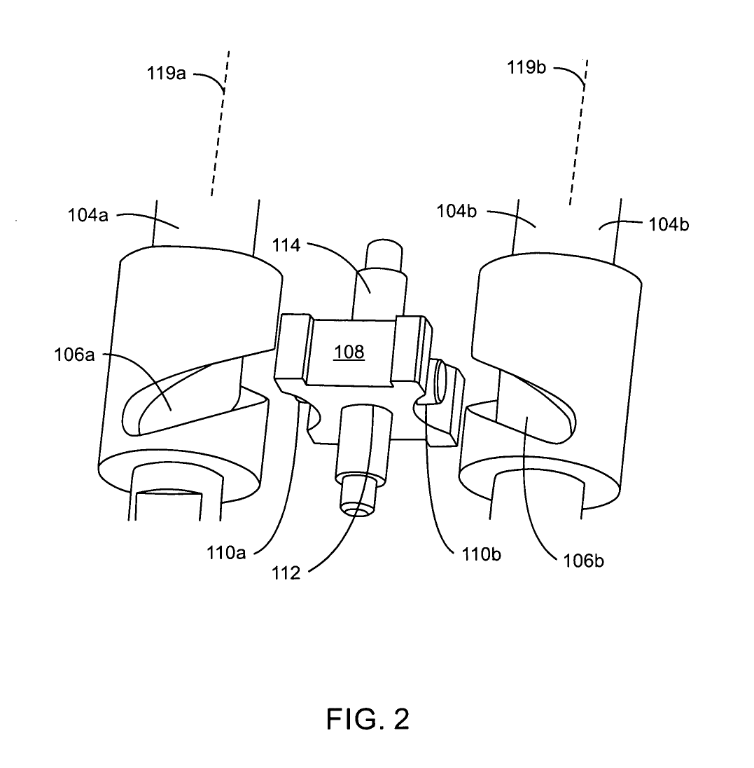

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure relates generally to a thin hinge assembly that enables 360 degree rotation of one hinged device relative to the other hinged device. The hinge assembly can easily be produced in large volumes. In one embodiment, the hinge assembly includes two axles having orbital grooves in their outer circumferential surfaces. A center “slider” includes two opposing pins each received in a respective one of the orbital grooves. The center slider in conjunction with the orbital grooves synchronizes the movement of the two hinged devices such that each hinged device rotates an approximately equal amount relative to two axes that are coincident with the two axles.

The hinge assembly has a relatively low number of parts, which facilitates mass production of the hinge assembly. The orbital grooves enable the two hinged devices to conjointly smoothly transition between the open and closed positions. The hinge assembly is also very thin, and may have a thickness that is equal to or less than the total thickness of the two hinged devices. In one embodiment, the hinge thickness is about five millimeters and the hinge width is about eight millimeters.

FIGS. 1A-2 illustrate one embodiment of a hinge assembly 100A of the present disclosure, including two torque elements 102a, 102b, two orbit axles 104a, 104b each having a respective one of two spiral or orbital grooves 106a, 106b. A slider 108 has two opposing pins 110a, 110b each received in a respective one of grooves 106a, 106b. Grooves 106a, 106b may be mirror images of each other such that pins 110a, 110b may each remain in a respective one of grooves 106a, 106b regardless of the rotational positions of axles 104a, 104b, which positions may also be mirror images of each other (e.g., axles 104a, 104b may rotate symmetrically). Slider 108 includes a central throughhole 112 in which is slidingly received a cylindrical shaft 114. Attached to each of axles 104a, 104b is a respective one of two mounting brackets 116a, 116b. Attached to each mounting bracket 116a, 116b is a respective one of two planar sections 118a, 118b which hinge assembly 100 enable to rotate relative to each other about respective axes 119a, 119b which are coincident with axles 104a, 104b. In examples, section 118a may be the keyboard of a laptop computer, and section 118b may be the display screen of the laptop computer, for example.

FIG. 1B illustrates an open structure, with a hinge 100B. In embodiments, the open structure is an electronic device. The hinge 100B is similar to that the hinge 100A (FIG. 1A). Moreover, similar to the hinge 100A (FIG. 1A), the hinge 100B is to include orbital grooves that enables the two hinged portions 118A and 118B of a computing device to conjointly smoothly transition between the open and closed positions. As illustrated, the hinge 100B is positioned such that the device 118, which includes two hinged portions 118A and 118B, is open.

FIG. 1C illustrates a closed structure, with a hinge 100C. In embodiments, the closed structure is an electronic device. The hinge 100C is similar to that the hinge 100A (FIG. 1A). The hinge 100C is Moreover, similar to the hinge 100A (FIG. 1A), the hinge 100B is to include orbital grooves that enables the two hinged portions 118A and 118B of a computing device to conjointly smoothly transition between the open and closed positions. As illustrated, the hinge 100C is positioned such that the structure 118, which includes two hinged portions 118A and 118B, is closed.

The hinge assembly as described herein may be used to couple any two structures. For example, the hinge assembly can be used to couple a housing of an electronic device, such as a laptop. A housing as used herein, may be a casing, cover, or other enclosure. In examples, the housing may be the enclosure for a tower computing device, and the hinge assembly may be positioned on the enclosure to enable access to computing components. Additionally, in examples, the housing may be a laptop housing, such that a first housing is used to enclose a display, camera, speaker, microphone, and the like of the laptop. A second housing may be used to couple a keyboard, touchpad, processor, storage, battery, microcontroller, of the laptop. Further, each of the first housing and the second housing can both include displays. In embodiments, each housing may include multiple displays, where the multiple displays are smaller displays or full-size displays. The housings may include displays on both sides of each of the housings or on one of the housings. Further, each housing may include various ports and openings of enable physical connections with other devices. While various electronic components have been listed and described with regard to the housings, the present techniques should not be limited to those components. Moreover, the various electronic components can be arranged between the first housing and the second housing as necessary, without being limited to one housing.

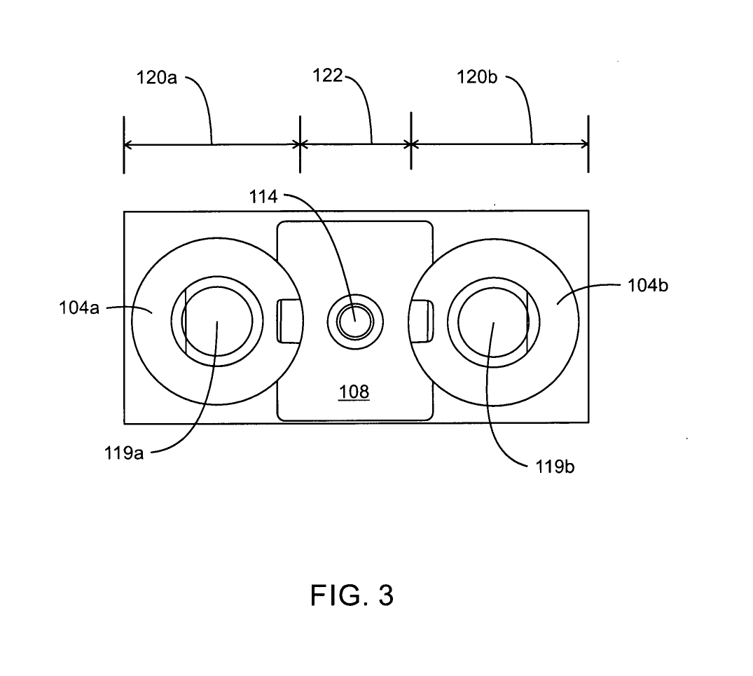

The thicknesses 120a, 120b (FIG. 3) of axles 104a, 104b may be as small as approximately two millimeters, and the thickness 122 of slider 108 may be as small as two millimeters, yielding a total thickness of hinge assembly 100A that may be as small as eight millimeters.

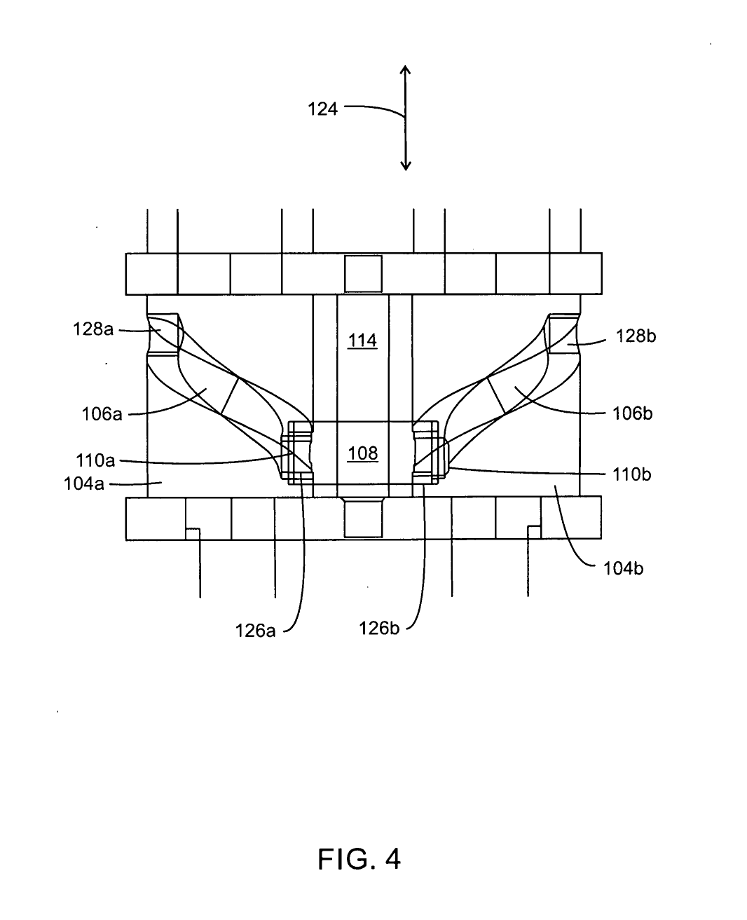

During rotation of axles 104a, 104b, slider 108 may move laterally in directions indicated by double arrow 124 to synchronize rotation of the two axles 104a, 104b and the two portions 118a, 118b. Pins 110a, 110b may traverse in grooves 106a, 106b such that axles 104a, 104b are forced to rotate to a same degree relative to a plane that includes both axes 119a, 119b. FIG. 4 illustrates positions of pins 110a, 110b at respective ends 126a, 126b of grooves 106a, 106b, which may correspond to the two portions 118a, 118b being fully rotated to a “back-to-back” position in which a bottom of a laptop keyboard may be touching a top cover of the laptop display screen, for example. In this position, it is possible for the display screen to be used as a tablet computer. The rotation at this position may be approximately 360 degrees. Conversely, pins 110a, 110b may be at respective opposite ends 128a, 128b of grooves 106a, 106b when the two portions 118a, 118b are fully rotated in the opposite direction to a closed position in which the laptop display screen fully covers the keyboard, for example. In this position, the device may be fully closed at approximately 0 degrees of rotation.

The level of torque required to rotate the two portions 118a, 118b about axes 119a, 119b, or the level of resistance to such rotation, may be determined by torque elements 102a, 102b, which may be compressible washers, for example. This level of torque may be easily adjusted by replacing torque elements 102a, 102b with other torque elements that are looser or tighter, depending upon the application requirements. In one embodiment the torque required for rotation may be greater than the torque exerted by the weight of either of electronic devices 118a, 118b. Thus, once set to a given angle relative to each other, portions 118a, 118b may hold that angle until the user again manually moves portions 118a, 118b to another angle. If the user holds the two portions 118a, 118b and tries to rotate them relative to each other, the resistance of both torque elements 102a, 102b may need to be overcome since slider 108 causes both portions 118a, 118b to rotate in synchrony. That is, both portions 118a, 118b may move evenly in the user's hands, and the user does not need to fully rotate the one of portions 118a, 118b that has the weaker torque element before he is able to rotate the other electronic device.

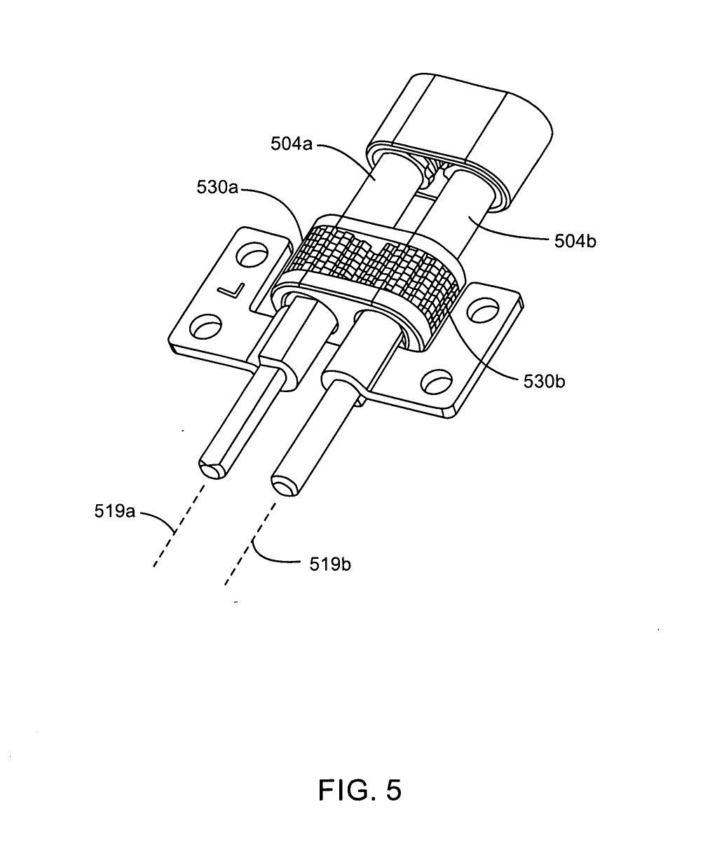

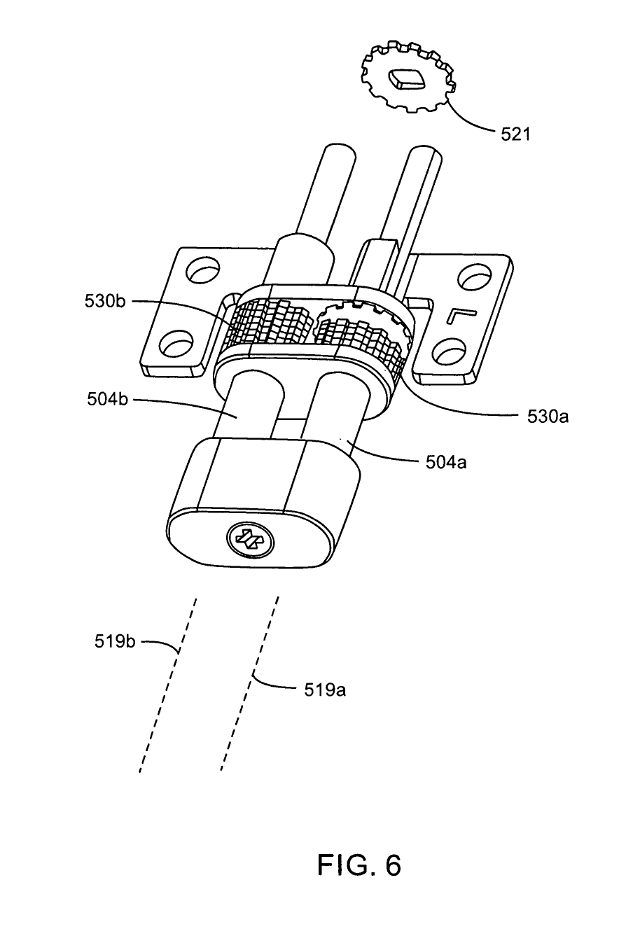

FIGS. 5-6 illustrate another embodiment of the present disclosure, including a geared hinge assembly 500. Geared hinge assembly 500 may be similar to hinge assembly 100 except that synchronization of the rotation of axles 504a, 504b may be achieved by respective sets 530a, 530b of gears on axles 504a, 504b. Gear set 530a may mesh with gear set 530b such that axles 504a, 504b symmetrically rotate to a same degree about axes 519a, 519b which are coincident with axles 504a, 504b. One individual gear 521 is shown in isolation in FIG. 6. In embodiments, if the geared function requires a helical gear engagement rather than a spur gear engagement as illustrated, each slide of the gear can be offset by a small amount (180 divided by number of gear slices) to create a helical gear.

Each gear set 530a, 530b is illustrated as having seven parallel gears, but it is to be understood that the gear sets may include any number of gears. Moreover, the gears in each set are shown as being side-by-side, stacked, or adjacent to all the other gears in the same set. However, the gears may be broken up into multiple smaller sets of gears spaced out along axles 504a, 504b. For ease and economy of manufacture, each of the gears may be stamped out of sheet metal.

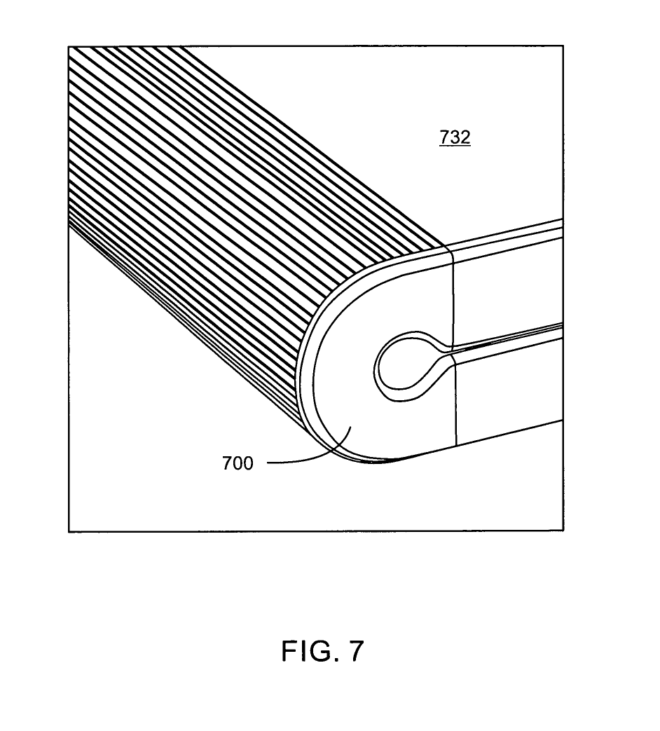

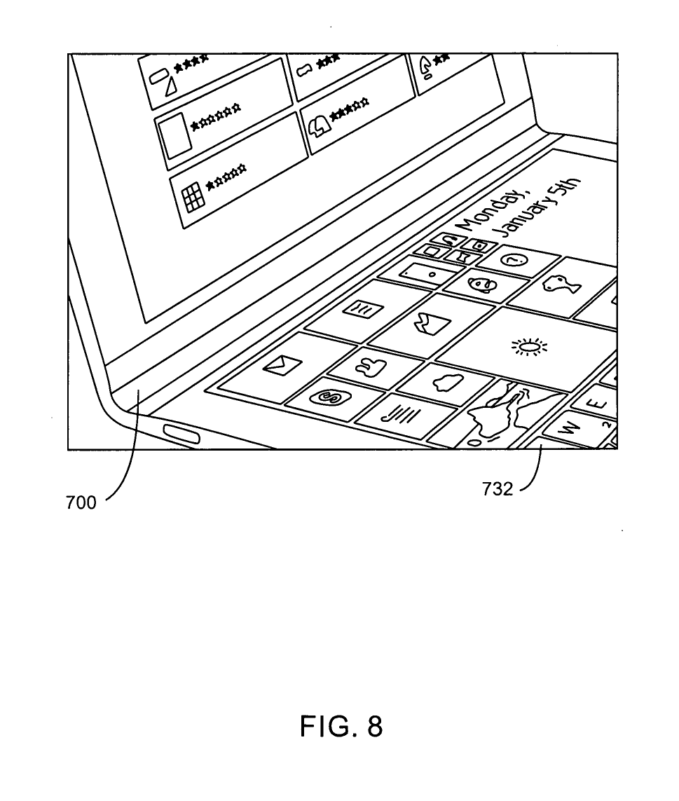

FIGS. 7-10 illustrate another embodiment of the present disclosure, including a laptop computer 732 having a multi-joint hinge assembly 700. Laptop computer 732 is shown in a closed position in FIG. 7, with hinge assembly 700 fully rotated in one direction. Laptop computer 732 is shown in a partially open position in FIG. 8, and it can be seen that hinge assembly 700 has a very clean inner diameter with a custom plastic rubber, elastomeric, or compliant material over-mold. When hinge assembly 700 is curved, as in FIGS. 7-8, the inner diameter of hinge assembly 700 may be compressed, and the outer diameter of hinge assembly 700 may be stretched.

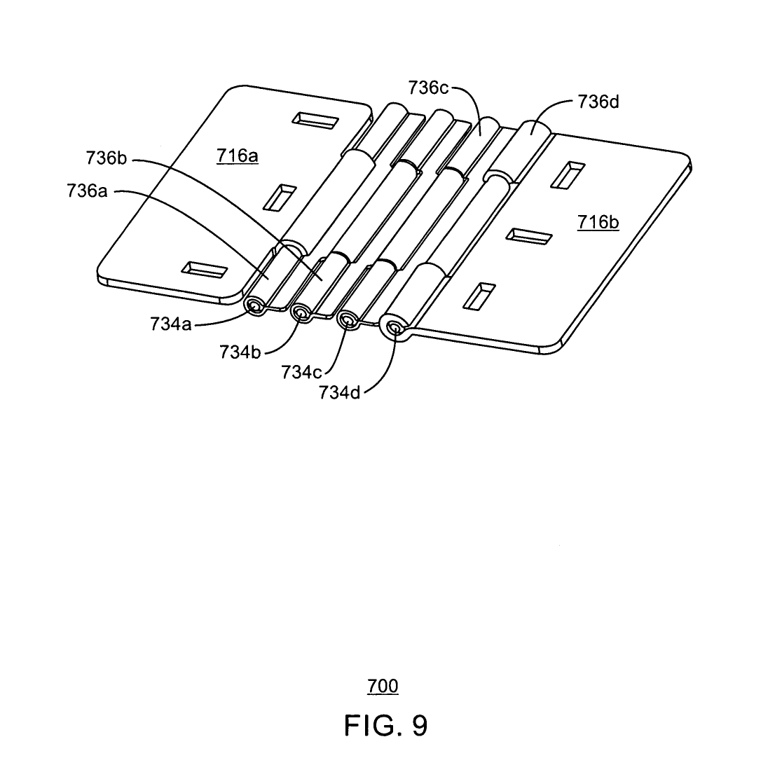

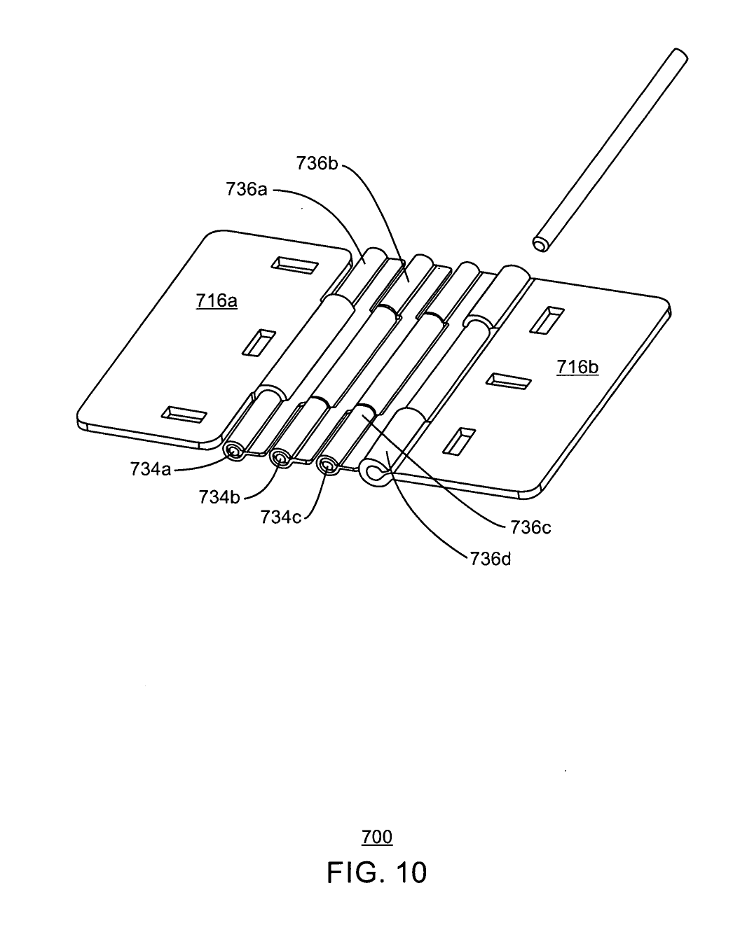

FIG. 9 illustrates hinge assembly 700 in isolation without any plastic overmolding. Hinge assembly 700 includes four hinges, each including one of pins 734a, 734b, 734c, 734d. Pin 734d is shown in isolation in FIG. 10. However, the hinge assembly may include any number of hinges, which number may depend upon the distance that is to be bridged between the two portions. Each hinge includes a cylindrical shell 736a, 736b, 736c, 736d that wraps around its respective one of pins 734a, 734b, 734c, 734d with an interference fit. The tightness with which the shells are wrapped around the pins may determine the resistance to rotation of hinge assembly 700, or the amount of torque that needs to be exerted on the two portions in order to cause their rotation. Outer shells 736a, 736d may be attached to respective ones of mounting brackets 716a, 716b, and may rotate therewith.

An end of each cylindrical shell 736a, 736b, 736c, 736d may include a stop (not shown) that limits the range of rotation of each hinge. Each hinge may consecutively provide a respective range of rotation to hinge assembly 700 as a whole. In one embodiment the total range of rotation of hinge assembly 700 may be about 360 degrees.

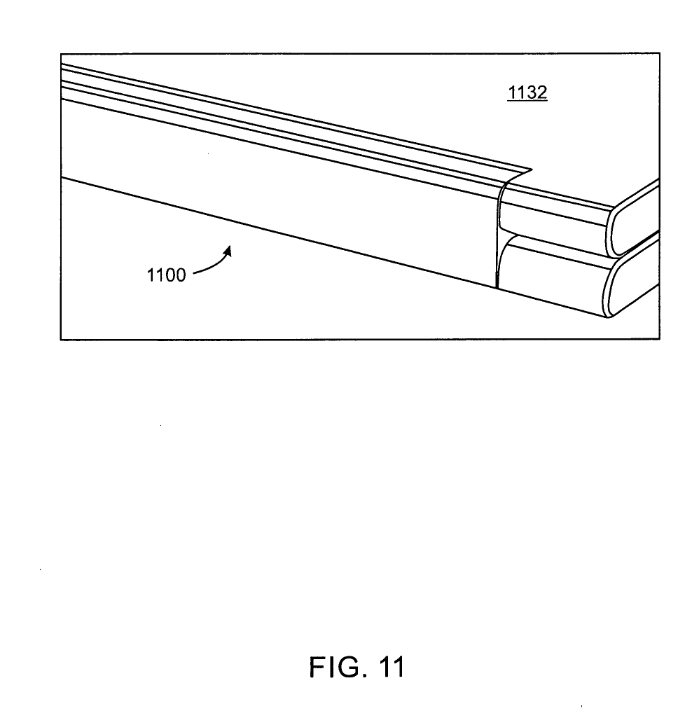

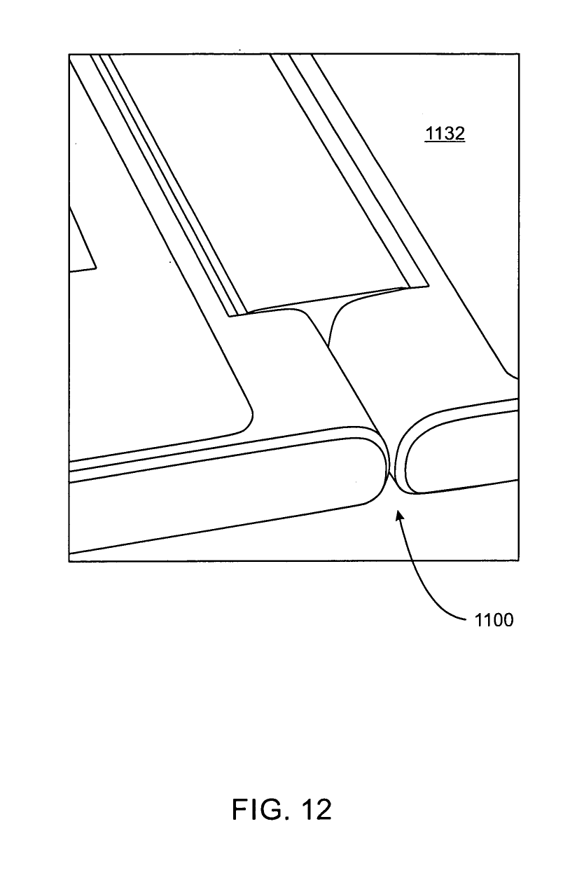

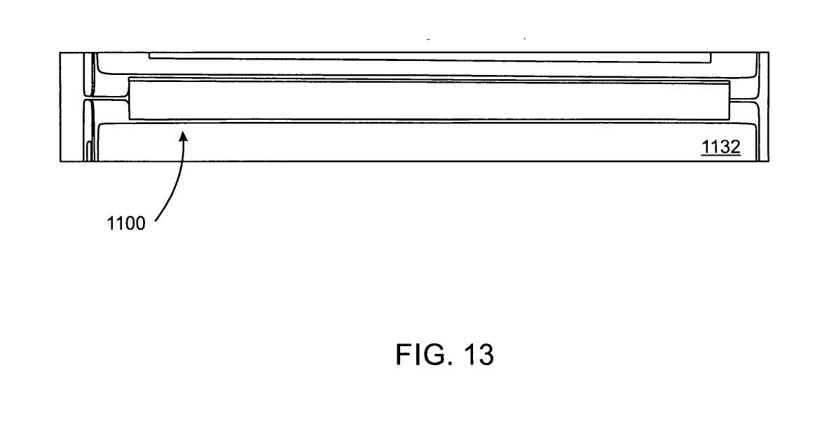

FIGS. 11-15 illustrate another embodiment of the present disclosure, including a laptop computer 1132 having a dual axis hinge assembly 1100. Laptop computer 1132 is shown in a closed position in FIG. 11, with hinge assembly 1100 fully rotated in one direction. Laptop computer 1132 is shown in an open position in FIGS. 12-13 wherein the keyboard and display screen are laid flat or are coplanar.

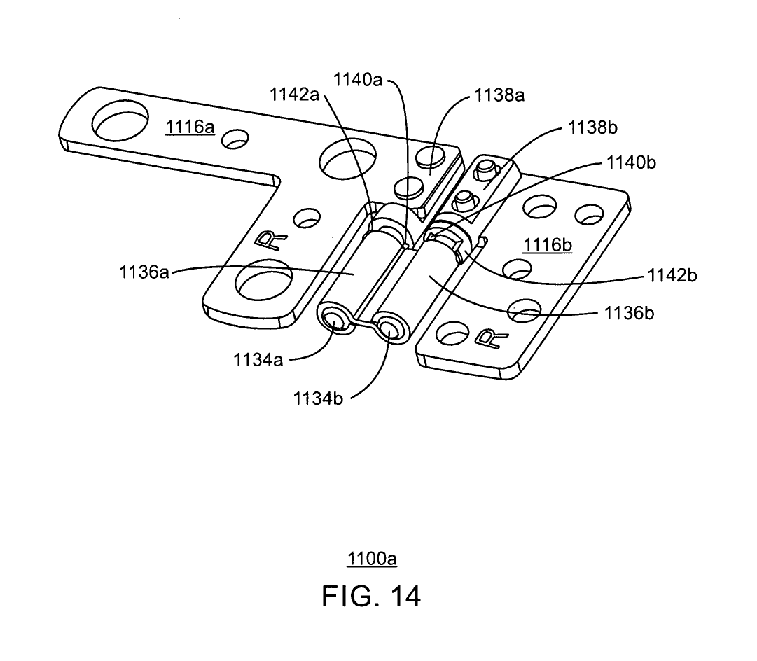

FIG. 14 illustrates hinge assembly 1100a in isolation without any plastic overmolding. Hinge assembly 1100a includes two hinges, each including a respective one of pins 1134a, 1134b. Each hinge includes a respective cylindrical shell 1136a, 1136b which may be fixedly attached to one another. Each shell 1136a, 1136b may wrap around its respective one of pins 1134a, 1134b with an interference fit. The tightness with which the shells are wrapped around the pins may determine the resistance to rotation of hinge assembly 1100a, or the amount of torque that needs to be exerted on the two portions in order to cause their rotation.

Each of pins 1134a, 1134b may be fixedly attached to a respective one of mounting brackets 1116a, 1116b through a respective one of sockets 1138a, 1138b.

An end of each cylindrical shell 1136a, 1136b may include a respective one of stops 1140a, 1140b that engages a corresponding one of shoulders 1142a, 1142b of sockets 1138a, 1138b at the end of the range of rotation. Thus, stops 1140a, 1140b and shoulders 1142a, 1142b conjointly limit the range of rotation of each hinge.

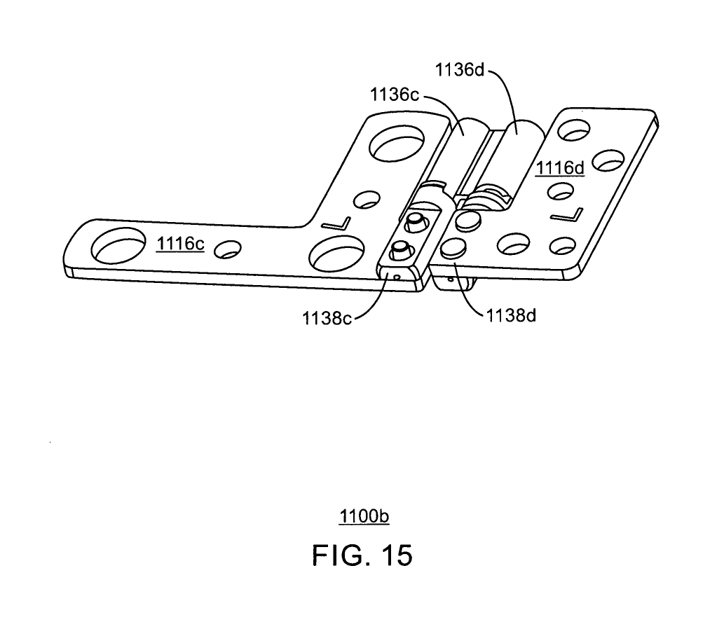

FIG. 14 illustrates one hinge assembly 1100a on one end of a laptop computer, for example, and FIG. 15 illustrates another hinge assembly 1100b on the other, opposite end of the laptop computer. Hinge assembly 1100b includes two hinges, each including a respective cylindrical shell 1136c, 1136d which may be fixedly attached to one another. Mounting brackets 1116c, 1116d may each be attached to a respective one of sockets 1138c, 1138d.

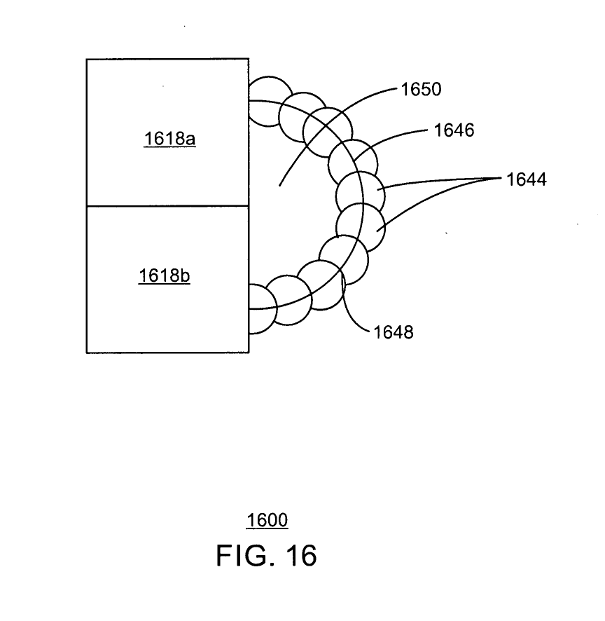

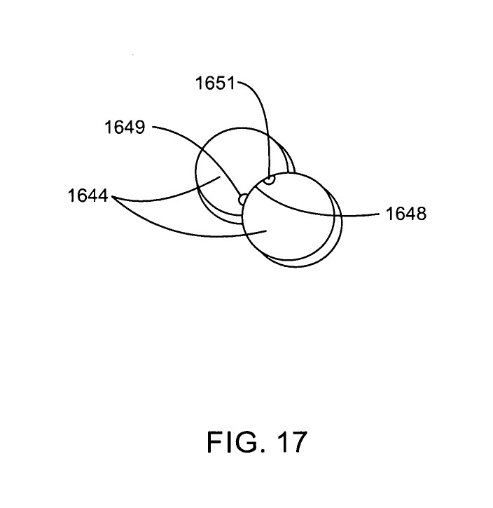

FIGS. 16-17 illustrate a further embodiment of a hinge assembly 1600 of the present disclosure, including a plurality of rollers 1644 coupled together to form a curved or semi-circular arc. Rollers 1644 may be coupled together in series by a wire 1646 having opposite ends each attached to a respective one of portions 1618a, 1618b. Each roller 1644 may include a throughhole through which wire 1646 is threaded to hold rollers 1644 in tight engagement. Each roller 1644 includes a concave cavity or notch 1648 in which the convex cylindrical surface of an adjacent roller 1644 is received. The shape of each roller 1644 may be cylindrical except for notch 1648. The throughhole of each roller 1644 may extend between the convex surface of roller 1644 and the concave notch 1648 of roller 1644.

The surface of each roller 1644 within notch 1648 may be serrated or textured such that there is positive engagement between the rollers, and, in conjunction with wire 1646 being taut or high tension, hinge assembly 1600 has some resistance to rotation or bending. The texturing of the concave notch surface may be provided by etching, splines, flutes, or crosshatching, for example. The concave notch surface may be made of a hard ceramic material or a metal treated for surface hardening, for example. The tension in wire 1646 may keep the convex surfaces of rollers 1644 in constant contact with the textured concave surfaces of adjacent rollers. Thus, longitudinally oriented flutes or splines in the concave surfaces may provide the user with a notch-to-notch, or stepped feel when rotating portions 1618a, 1618b.

Rollers 1644 and portions 1618a, 1618b may define therebetween a semi-cylindrical conduit 1650 which may carry electrical conductors between portions 1618a, 1618b, for example. The electrical conductors may include antennas, docking components, and display conductors, for example.

FIG. 17 is an enlarged view of two rollers 1644 of the hinge assembly 1600 of FIG. 16, showing the engagement between the two rollers 1644. The concave surface of roller 1644 is shown to include a flute 1649 and a spline 1651 for purposes of illustration. However, it is to be understood that the concave surface of roller 1644 may include a plurality of flute 1649 and no spline, or a plurality of splines 1651 and no flute. These flutes and/or splines may alternatively be provided on the concave surface of roller 1644 that engages the concave surface of another roller 1644.

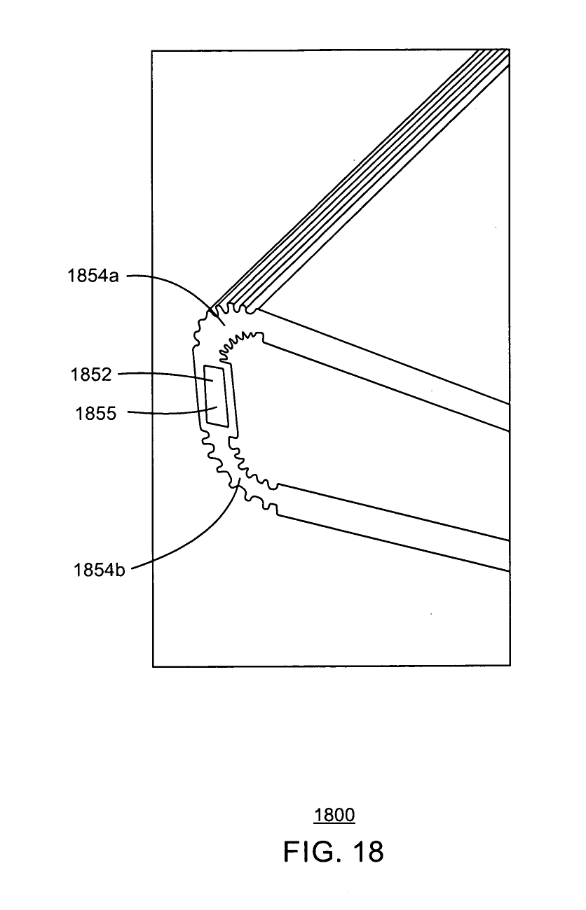

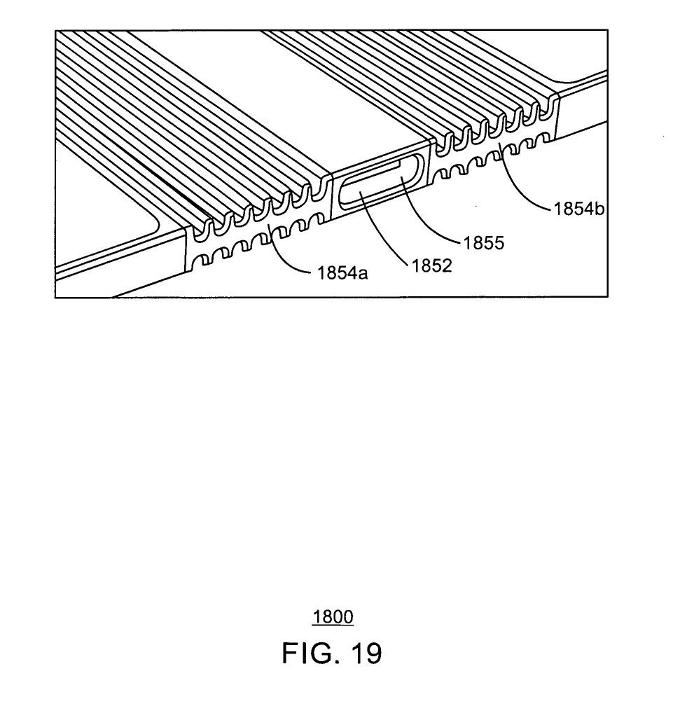

FIG. 18 illustrates a laptop computer of the present disclosure in a closed position. The laptop computer includes a multi-joint hinge assembly 1800 with a separation gap 1852 between two multi-axle and multi-hinge hinge sets 1854a, 1854b. Disposed within separation gap 1852 may be a conduit 1855 housing, containing, or carrying electronics therein, such as electrical connectors. Conduit 1855 may be oriented parallel to hinge sets 1854a, 1854b. Hinge sets 1854a, 1854b may be covered by rubberized grips. Multi-axle hinge sets 1854a, 1854b may be implemented in the form of multi-joint hinge assemblies 700 or hinge assemblies 1600, for example. The range of rotation of the laptop computer via multi-joint hinge assembly 1800 may be up to 360 degrees. FIG. 19 illustrates the laptop computer of FIG. 18 in an open position.

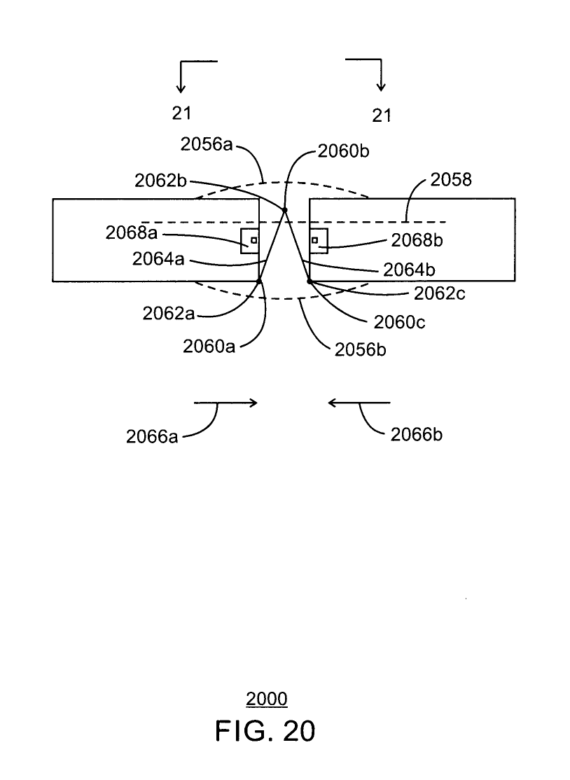

FIGS. 20-22 illustrate a laptop computer including a three-axis hinge assembly 2000 of the present disclosure including a flexible cosmetic covers 2056a, 2056b. A cable 2058 interconnects the two electronic halves of the laptop computer and carries electronic signals therebetween. Hinge assembly 2000 includes three axles 2660a, 2060b, 2060c each having a respective one of hinge pins 2062a, 2062b, 2062c. Hinge pin 2062a is connected to hinge pin 2062b by plates 2064a, and hinge pin 2062b is connect to hinge pin 2062c by plates 2064b. Axles 2060a, 2060c may each enable 360 degrees of rotation. Axle 2060b may enable the two electronic halves of the laptop computer to come together in the opposite directions indicated by arrows 2066a, 2066b when the laptop computer is laid open or is lying flat, as shown in FIG. 20. By the two electronic halves of the laptop computer coming together, the distance between the displays on each half may be minimized in order to make the displays appear to be one single, continuous display. Magnets 2068a, 2068b spaced along the width of the laptop computer (i.e., along a direction into the page of FIG. 20) may be attracted to each other to thereby pull together the two electronic halves of the laptop computer. Hinge assembly 2000 may be expandable and compressible (e.g., accordion style) to enable magnets 2068a, 2068b to pull the two electronic halves of the laptop computer together.

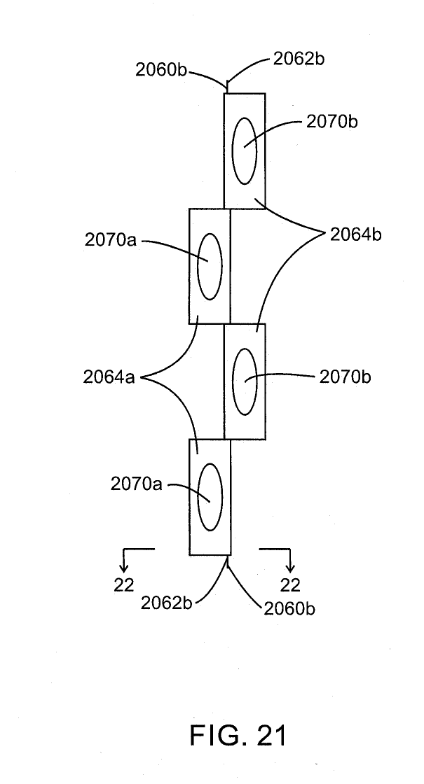

FIG. 21 is a top view of the hinge assembly 2000 of FIG. 20 along line 21-21. Plates 2064a, 2064b may include oval-shaped throughholes 2070a, 2070b to avoid blocking the magnetic fields produced by magnets 2068a, 2068b and to thereby increase the level of attractive force exerted by magnets 2068a, 2068b on each other.

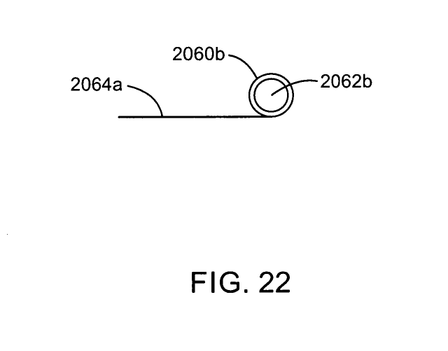

FIG. 22 is a cross-sectional view of the hinge assembly of FIG. 21 along line 22-22, illustrating the wrapping of plates 2064a, 2064b around hinge pins 2062a, 2062b, 2062c.

The present disclosure may describe hinge assemblies including multiple parallel hinges wherein the two outermost hinges are fixedly attached to a respective one of the two portions. Such hinge assemblies may include as few as two parallel hinges wherein each of the two hinges is an outermost hinge fixedly attached to a respective one of the two portions.

Example 1 is an apparatus. The apparatus includes a hinge assembly including a plurality of substantially parallel hinges, each said hinge of the plurality being attached to at least one adjacent said hinge, wherein a first outermost hinge is coupled to a first housing and a second outermost hinge is coupled to a second housing, each said hinge of the plurality to provide a respective range of rotation to the hinge assembly such that the first and second housings may be rotated relative to each other about the hinge assembly within a range of approximately between 0 degrees and 360 degrees.

Example 2 includes the apparatus of example 1, including or excluding optional features. In this example, each of the first housing and the second housing has a respective thickness, the hinge assembly having a thickness in a direction perpendicular to each of the first housing and the second housing, when each of the first housing and the second housing are parallel and in engagement with each other, that is less than or equal to a sum of the respective thicknesses of the two substantially planar devices.

Example 3 includes the apparatus of any one of examples 1 to 2, including or excluding optional features. In this example, the hinge assembly includes two substantially parallel hinges, each of the two hinges including a respective axle with a spiral groove, the two spiral grooves being symmetrical, the apparatus further including a slider having two opposing pins, each said pin being received in a respective one of the spiral grooves. Optionally, the slider moves in a direction parallel to the axles as the two substantially planar devices rotate relative to each other about the hinge assembly.

Example 4 includes the apparatus of any one of examples 1 to 3, including or excluding optional features. In this example, the hinge assembly includes two substantially parallel hinges, each of the two hinges including a respective one of a set of parallel first gears and a set of parallel second gears, each of the first gears meshing with a respective one of the second gears. Optionally, each of the first gears and each of the second gears is stamped out of sheet metal.

Example 5 includes the apparatus of any one of examples 1 to 4, including or excluding optional features. In this example, the first housing includes a first magnet associated with a first surface, and the second housing includes a second magnet associated with a second surface, the first surface opposing the second surface such that the first magnet and the second magnet mutually attract each other. Optionally, at least one of the hinges is attached to at least one corresponding plate having a throughhole aligned with the two magnets. Optionally, the hinge assembly is expandable and compressible to enable the magnets to pull the two substantially planar devices together.

Example 6 includes the apparatus of any one of examples 1 to 5, including or excluding optional features. In this example, the hinge assembly includes: two multi-axle hinge sets; and a conduit disposed between and oriented parallel to the multi-axle hinge sets.

Example 7 is a system. The system includes a first electronic component; a second electronic component; a first housing to house at least the first electronic component; a second housing to house at least the second electronic component; and a hinge assembly including a plurality of substantially parallel hinges, each said hinge of the plurality being attached to at least one adjacent said hinge of the plurality, wherein a first outermost hinge is coupled to the first housing and a second outermost hinge is coupled to the second housing, each said hinge of the plurality to provide a respective range of rotation to the hinge assembly such that the first and second housings may be rotated relative to each other about the hinge assembly within a range of approximately between 0 degrees and 360 degrees.

Example 8 includes the system of example 7, including or excluding optional features. In this example, each hinge of the plurality of hinges includes a respective axle with a spiral groove, the two spiral grooves being symmetrical, the system further including a slider having two opposing pins, each said pin being received in a respective one of the spiral grooves. Optionally, the slider moves in a direction parallel to the axles as the first housing and the second housing rotates relative to each other about the hinge assembly.

Example 9 includes the system of any one of examples 7 to 8, including or excluding optional features. In this example, the hinge assembly includes two substantially parallel hinges, each of the two hinges including a respective one of a set of parallel first gears and a set of parallel second gears, each of the first gears meshing with a respective one of the second gears. Optionally, each of the first gears and each of the second gears is stamped out of sheet metal.

Example 10 includes the system of any one of examples 7 to 9, including or excluding optional features. In this example, the first housing includes a plurality of substantially aligned first magnets associated with a first surface, and the second housing includes a plurality of substantially aligned second magnets associated with a second surface, the first surface opposing the second surface such that each of the first magnets opposes and is attracted to a respective one of the second magnets. Optionally, each hinge of the plurality of hinges is attached to at least one corresponding plate of a plurality of plates, each said plate having a throughhole, each of the throughholes being aligned with a respective one of the first magnets and with a respective one of the second magnets. Optionally, the hinge assembly is expandable and compressible to enable the magnets to pull the first housing and the second housing together.

Example 11 includes the system of any one of examples 7 to 10, including or excluding optional features. In this example, the hinge assembly includes: two multi-axle hinge sets; and a conduit disposed between and oriented parallel to the multi-axle hinge sets.

Example 12 includes the system of any one of examples 7 to 11, including or excluding optional features. In this example, the first housing and the second housing are substantially planar.

Example 13 is an electronic apparatus. The apparatus includes a hinge assembly including a plurality of substantially parallel rollers, each said roller having a concave notch in which is received a convex surface of an adjacent said roller, each said roller having a throughhole oriented substantially perpendicular to a length of said roller, a wire having two opposite ends each attached to a respective one of a first housing and a second housing, the wire extending through each of the throughholes of the rollers.

Example 14 includes the apparatus of example 13, including or excluding optional features. In this example, the throughhole of each said roller extends between the convex surface of said roller and the concave notch of said roller.

Example 15 includes the apparatus of any one of examples 13 to 14, including or excluding optional features. In this example, the first housing and the second housing and the hinge assembly define therebetween a semi-cylindrical conduit carrying electrical conductors between the two substantially planar electronic devices.

Example 16 includes the apparatus of any one of examples 13 to 15, including or excluding optional features. In this example, the wire is under tension.

Example 17 includes the apparatus of any one of examples 13 to 16, including or excluding optional features. In this example, the convex surface of each said roller and/or the concave notch surface of each said roller is textured. Optionally, the textured surface includes flutes or splines.

Example 18 includes the apparatus of any one of examples 13 to 17, including or excluding optional features. In this example, each of the first housing and the second housing has a respective thickness, the hinge assembly having a thickness in a direction perpendicular to each of the first housing and the second housing, when each of the first housing and the second housing are parallel and in engagement with each other, that is less than or equal to a sum of the respective thicknesses of the two substantially planar devices.

Example 19 includes the apparatus of any one of examples 13 to 18, including or excluding optional features. In this example, the shape of each roller is cylindrical.

Example 20 includes the apparatus of any one of examples 13 to 19, including or excluding optional features. In this example, the first housing and the second housing are substantially planar.

Example 21 includes the apparatus of any one of examples 13 to 20, including or excluding optional features. In this example, the first housing is to house at least a first electronic component, and the second housing is to house at least a second electronic component.

Example 22 is an apparatus. The apparatus includes a means to enable a range of rotation being attached to at least one another means to enable a range of rotation, wherein a means to enable a range of rotation is coupled to a first housing and a second means to enable a range of rotation being is coupled to a second housing, each said means to enable a range of rotation to provide a respective range of rotation such that the first and second housings may be rotated relative to each other about the means to enable a range of rotation being within a range of approximately between 0 degrees and 360 degrees.

Example 23 includes the apparatus of example 22, including or excluding optional features. In this example, each of the first housing and the second housing has a respective thickness, the hinge assembly having a thickness in a direction perpendicular to each of the first housing and the second housing, when each of the first housing and the second housing are parallel and in engagement with each other, that is less than or equal to a sum of the respective thicknesses of the two substantially planar devices.

Example 24 includes the apparatus of any one of examples 22 to 23, including or excluding optional features. In this example, the means to enable a range of rotation includes two substantially parallel hinges, each of the two hinges including a respective axle with a spiral groove, the two spiral grooves being symmetrical, the apparatus further including a slider having two opposing pins, each said pin being received in a respective one of the spiral grooves. Optionally, the slider moves in a direction parallel to the axles as the two substantially planar devices rotate relative to each other about the hinge assembly.

Example 25 includes the apparatus of any one of examples 22 to 24, including or excluding optional features. In this example, the means to enable a range of rotation includes two substantially parallel hinges, each of the two hinges including a respective one of a set of parallel first gears and a set of parallel second gears, each of the first gears meshing with a respective one of the second gears. Optionally, each of the first gears and each of the second gears is stamped out of sheet metal.

Example 26 includes the apparatus of any one of examples 22 to 25, including or excluding optional features. In this example, the first housing includes a first magnet associated with a first surface, and the second housing includes a second magnet associated with a second surface, the first surface opposing the second surface such that the first magnet and the second magnet mutually attract each other. Optionally, the means to enable a range of rotation includes a plurality of hinges, and at least one of the hinges is attached to at least one corresponding plate having a throughhole aligned with the two magnets. Optionally, the means to enable a range of rotation is expandable and compressible to enable the magnets to pull the two substantially planar devices together.

Example 27 includes the apparatus of any one of examples 22 to 26, including or excluding optional features. In this example, the means to enable a range of rotation includes: two multi-axle hinge sets; and a conduit disposed between and oriented parallel to the multi-axle hinge sets.

Example 28 is an apparatus. The apparatus includes two substantially portions communicatively coupled to each other; and a hinge assembly including a plurality of substantially parallel hinges, each said hinge being attached to at least one adjacent said hinge, two outermost ones of the hinges being attached to a respective one of the two substantially portions, each said hinge to provide a respective range of rotation to the hinge assembly such that the two substantially portions may be rotated relative to each other about the hinge assembly within a range of approximately between 0 degrees and 360 degrees.

Example 29 includes the apparatus of example 28, including or excluding optional features. In this example, each said substantially planar device has a respective thickness, the hinge assembly having a thickness in a direction perpendicular to the two substantially portions, when the two substantially portions are parallel and in engagement with each other, that is less than or equal to a sum of the respective thicknesses of the two substantially portions.

Example 30 includes the apparatus of any one of examples 28 to 29, including or excluding optional features. In this example, the hinge assembly includes two substantially parallel hinges, each of the two hinges including a respective axle with a spiral groove, the two spiral grooves being symmetrical, the apparatus further including a slider having two opposing pins, each said pin being received in a respective one of the spiral grooves. Optionally, the slider moves in a direction parallel to the axles as the two substantially portions rotate relative to each other about the hinge assembly.

Example 31 includes the apparatus of any one of examples 28 to 30, including or excluding optional features. In this example, the hinge assembly includes two substantially parallel hinges, each of the two hinges including a respective one of a set of parallel first gears and a set of parallel second gears, each of the first gears meshing with a respective one of the second gears.

Example 32 includes the apparatus of any one of examples 28 to 31, including or excluding optional features. In this example, each of the first gears and each of the second gears is stamped out of sheet metal.

Example 33 includes the apparatus of any one of examples 28 to 32, including or excluding optional features. In this example, a first one of the two substantially portions includes a first magnet associated with a first surface, and a second one of the two substantially portions includes a second magnet associated with a second surface, the first surface opposing the second surface such that the first magnet and the second magnet mutually attract each other. Optionally, at least one of the hinges is attached to at least one corresponding plate having a throughhole aligned with the two magnets. Optionally, the hinge assembly is expandable and compressible to enable the magnets to pull the two substantially portions together.

Example 34 includes the apparatus of any one of examples 28 to 33, including or excluding optional features. In this example, the hinge assembly includes: two multi-axle hinge sets; and a conduit disposed between and oriented parallel to the multi-axle hinge sets.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementation's, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus, comprising:
a hinge assembly including a plurality of substantially parallel hinges, each said hinge of the plurality being attached to at least one adjacent said hinge, wherein a first outermost hinge is coupled to a first housing and a second outermost hinge is coupled to a second housing, each said hinge of the plurality to provide a respective range of rotation to the hinge assembly such that the first and second housings may be rotated relative to each other about the hinge assembly within a range of approximately between 0 degrees and 360 degrees.

2. The apparatus of claim 1, wherein each of the first housing and the second housing has a respective thickness, the hinge assembly having a thickness in a direction perpendicular to each of the first housing and the second housing, when each of the first housing and the second housing are parallel and in engagement with each other, that is less than or equal to a sum of the respective thicknesses of the two substantially planar devices.

3. The apparatus of claim 1, wherein the hinge assembly includes two substantially parallel hinges, each of the two hinges including a respective axle with a spiral groove, the two spiral grooves being symmetrical, the apparatus further including a slider having two opposing pins, each said pin being received in a respective one of the spiral grooves.

4. The apparatus of claim 3, wherein the slider moves in a direction parallel to the axles as the two substantially planar devices rotate relative to each other about the hinge assembly.

5. The apparatus of claim 1, wherein the hinge assembly includes two substantially parallel hinges, each of the two hinges including a respective one of a set of parallel first gears and a set of parallel second gears, each of the first gears meshing with a respective one of the second gears.

6. The apparatus of claim 5, wherein each of the first gears and each of the second gears is stamped out of sheet metal.

7. The apparatus of claim 1, wherein the first housing includes a first magnet associated with a first surface, and the second housing includes a second magnet associated with a second surface, the first surface opposing the second surface such that the first magnet and the second magnet mutually attract each other.

8. The apparatus of claim 7, wherein at least one of the hinges is attached to at least one corresponding plate having a throughhole aligned with the two magnets.

9. The apparatus of claim 7, wherein the hinge assembly is expandable and compressible to enable the magnets to pull the two substantially planar devices together.

10. The apparatus of claim 1, wherein the hinge assembly includes:
two multi-axle hinge sets; and
a conduit disposed between and oriented parallel to the multi-axle hinge sets.

11. A system, comprising:
a first electronic component;
a second electronic component;
a first housing to house at least the first electronic component;
a second housing to house at least the second electronic component; and
a hinge assembly including a plurality of substantially parallel hinges, each said hinge of the plurality being attached to at least one adjacent said hinge of the plurality, wherein a first outermost hinge is coupled to the first housing and a second outermost hinge is coupled to the second housing, each said hinge of the plurality to provide a respective range of rotation to the hinge assembly such that the first and second housings may be rotated relative to each other about the hinge assembly within a range of approximately between 0 degrees and 360 degrees.

12. The system of claim 11, wherein each hinge of the plurality of hinges includes a respective axle with a spiral groove, the two spiral grooves being symmetrical, the system further including a slider having two opposing pins, each said pin being received in a respective one of the spiral grooves.

13. The system of claim 14, wherein the slider moves in a direction parallel to the axles as the first housing and the second housing rotates relative to each other about the hinge assembly.

14. The system of claim 11, wherein the hinge assembly includes two substantially parallel hinges, each of the two hinges including a respective one of a set of parallel first gears and a set of parallel second gears, each of the first gears meshing with a respective one of the second gears.

15. The system of claim 14, wherein each of the first gears and each of the second gears is stamped out of sheet metal.

16. The system of claim 11, wherein the first housing includes a plurality of substantially aligned first magnets associated with a first surface, and the second housing includes a plurality of substantially aligned second magnets associated with a second surface, the first surface opposing the second surface such that each of the first magnets opposes and is attracted to a respective one of the second magnets.

17. The system of claim 16, wherein each hinge of the plurality of hinges is attached to at least one corresponding plate of a plurality of plates, each said plate having a throughhole, each of the throughholes being aligned with a respective one of the first magnets and with a respective one of the second magnets.

18. The system of claim 16, wherein the hinge assembly is expandable and compressible to enable the magnets to pull the first housing and the second housing together.

19. The system of claim 11, wherein the hinge assembly includes:
two multi-axle hinge sets; and
a conduit disposed between and oriented parallel to the multi-axle hinge sets.

20. The system of claim 11, wherein the first housing and the second housing are substantially planar.

21. An electronic apparatus, comprising:
a hinge assembly including a plurality of substantially parallel rollers, each said roller having a concave notch in which is received a convex surface of an adjacent said roller, each said roller having a throughhole oriented substantially perpendicular to a length of said roller, a wire having two opposite ends each attached to a respective one of a first housing and a second housing, the wire extending through each of the throughholes of the rollers.

22. The apparatus of claim 21, wherein the throughhole of each said roller extends between the convex surface of said roller and the concave notch of said roller.

23. The apparatus of claim 21, wherein the first housing and the second housing and the hinge assembly define therebetween a semi-cylindrical conduit carrying electrical conductors between the two substantially planar electronic devices.

24. The apparatus of claim 21, wherein the wire is under tension.

25. The apparatus of claim 21, wherein the convex surface of each said roller and/or the concave notch surface of each said roller is textured.
